(19) United States
(12) Patent Application Publication
(10) Pub. No.: US 2005/0085359 A1
(43) Pub. Date: Apr. 21, 2005

(54) Machine tools

(76) Inventors: Hinrich Stave, Mindelheim (DE); Heinrich Lutz, Dirlewang (DE); Burkhart Grob, Bad Worishofen (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/726,698

(22) Filed: Dec. 4, 2003

(30) Foreign Application Priority Data
May 19, 2003 (DE) 203 07 905.1
Dec. 5, 2002 (DE) 102 57 151.1

(51) Int. Cl. B23Q 3/157

(52) U.S. Cl. 483/54

(57) ABSTRACT

The invention refers to machine tools, in particular for the metal cutting machining of workpieces, for which several machining spindles are provided, and wherein a tool magazine serves for supplying and changing the tools of at least two machining spindles. At least a part of the supplied tools and the tools which have to be changed are arranged in the same plane.

The invention refers to machine tools for the in particular cutting machining of work pieces by means of a machining unit which has at least one machining spindle, a tool magazine being provided which serves for supplying and changing the tools on the tool spindle.

### BACKGROUND OF THE INVENTION

The use of a tool magazine in machine tools which can be used variably is sufficiently known. For a quick change of tools which eventually determines also the cycle time of the machine tools it is basically convenient to store as many tools as possible in the range of the machining spindle, respectively the machining unit. Simultaneously a tool magazine shall also be able to carry out the changing procedure itself very fast.

Basically this leads to the positioning of comparatively large tool magazines in the range of the machining spindle; the weight of the tool magazine here is considerable.

Furthermore, on the known tool magazines also a device has to be provided which allows to bring the tool magazine into the range of the machining spindle for the tool changing procedure, as far as for that not the respective axis of movement of the tool spindle can be enlisted. The constructive effort and the space needed for the for the tool magazines is correspondingly large in this case of application, and this includes necessarily corresponding limitations of the working room which possibly borders directly on the tool magazine.

The known tool magazines are mounted here on separate holding devices near the machining spindle, the corresponding weights of the tool magazines having to be taken into consideration. This means that possibly in the working room, which is limited anyway, the access is impeded by means of stanchions which obstruct the access to the working room or limit the working room correspondingly. It has to be taken into consideration here that in particular with multiple spindle arrangements the working room has to be planned even more detailed and exactly because several machining have to be carried out in the narrow space parallel. The known collar constructions for fastening the tool magazine are not basically conform with the requirements of a highly exact machining of the machining spindles.

Furthermore in the state of the art machining tools are known which have several machining spindles. It is a disadvantage here that one magazine each is provided for one spindle. This leads to a corresponding high number of tool magazines in the working room. The movement of the spindles is therefore limited and it is only possible through corresponding additional effort to carry out even quite complex machining on such machine tools.

Machine tools as described above are known from the specification DE 197 08 096 A1. A machining center is presented there where at least one machining spindle with preferably horizontal spindle position can be traverse in X-, Y- and Z-direction, and each machining spindle is assigned at least one essentially cylinder-shaped tool store which can rotate around a central axis with store places for depositing of the tool(s) by means of the machining spindle(s). The tool store presented there comprises a tool disc or several tool discs arranged parallel to each other and collected to a drum storage, the tool discs being rotatable separately or together around a central axis arranged vertically to the spindle axis. The tool axes are orientated radial on the disc.

For changing the tools it is necessary to traverse the spindle in X-, respectively Y-direction until the position in front of the respective tool holder and then to enter in Z-direction between the tool discs until over the tool holder and eventually to lower a short way into the fork-shaped tool holder. By means of that the requirement for the machine tools themselves becomes very large as the spindle axes have to be designed in such a way that they can shift in X-, Y- and Z-direction.

It is also necessary to co-ordinate the procedures concerning the tools which have to be changed for several spindles in such a way that actually, as described in the specification, the tools can really be transferred simultaneously from different tool holders to different spindles. Here the tools of several spindles are only changed by the fact that the respective tools can be taken each from different discs arranged one above the other, and the result is that in the working room which is very narrow anyway a very large cylinder-shaped tool magazine has to be supplied.

Furthermore it may be necessary that the spindle has to traverse then into another plane in order to take a tool deposited there from a tool holder. By means of that also the operating cycles are slowed down leading altogether to longer machining times simply because of the changing of the machining tools.

### BRIEF SUMMARY OF THE INVENTION

The present invention has the object to improve known machine tools in such a way that the tool magazine is designed as space-saving as possible.

In order to solve this problem the invention proposes that at least a part of the supplied tools and the tools which have to be changed are arranged at the same plane.

According to the solution in the state of the art the tools which have to be changed may be in the same plane, the tools which have to be changed are arranged one above the other on different discs. However, all other supplied tools are not in this plane anymore, but they are on different discs in other positions which results in the comparatively large required space. The term plane has to be understood here as a plane surface, which is really a plane. The essential advantage of the invention is in particular the fact that by means of it a very space saving arrangement can be realised.

It has to be taken into consideration here that -in particular several tools which have to be changed as well as a part of the supplied tools are arranged at the same plane. In particular it has to be understood here that the tools that have to be changed of at least two machining spindles are in the same plane with other supplied tools.

By this suggestion the disadvantage according to the prior art is avoided. A tool magazine is supplied which is able to change the tools on at least two machining spindles. In a first variant here it is possible that the tools on the spindles are changed one after the other. The machine tools provide here that the tool magazine can be positioned on the respective machining spindle. In another variant of the invention it is provided that the tool magazine changes the tools simultaneously on more, at least on two machining spindles. By means of this embodiment of the invention a considerable additional time advantage is reached. The non-cutting times which occur anyhow because of the tool change are advantageously used according to this variant of the invention for the change of several tools which eventually results in the performance of such machine tools according to the invention, with reduction of the requirement of the tool magazine in the working room. The machine according to the invention becomes faster, respectively accomplishes more, and allows, on the other hand, also simultaneously the carrying out of more complex operations because the working room is only narrowed by the presence of the tool magazine. It has to be taken into consideration here that the tool magazine is located in the working room only during the period of the tool change and is otherwise arranged outside. The reduction of the tool magazines to a clearly smaller number as well as the number of machining spindles, however, results in a saving of the necessary guides which may project into the working room.

In another preferred embodiment of the invention it is provided that a connection line between the machining spindles is part of the plane. This is based on the fact that equal, respectively similar, positions of the spindles each are part of this connection line. For example, the connection line refers to the support surface of the spindle heads which support the tools. Alternatively it is, of course, possible that this connection line is not part of the plane but is arranged parallel to it. This alternative as well is comprised in the invention.

Furthermore it is provided according to the invention that the plane for the arrangement of the tools in the tool magazine is orientated essentially vertically or, alternatively to that, horizontally. In particular a vertical orientation has the advantage that a large part of the tools is arranged above the working room. In a horizontal orientation here the tools are arranged on the side close to the working room. Of course, it is possible here to orientate this plane angled in the space, however, this depends eventually from the respective machining task of the machine tools, optimising the respective arrangement.

It is provided here that in another variant according to the invention the spindle axis is orientated parallel or angled, in particular rectangular, to the plane. The tools are supplied in the tool magazine in such a way that the rotational axis of the tools is orientated angled, in particular rectangular, to the plane and thus in a simple way can be changed into the tool spindle. The tools are, in this embodiment, essentially upright with parallel spindle axes one beside the other in the tool magazine, making it possible to store a large number of tools upright one beside the other on a comparatively small surface.

Basically it is also possible according to the invention to arrange the tools not only in one row but also in multiple rows in the tool magazine and therefore increase further the density of available tools. In a multiple row arrangement of the tools in the tool magazine it is an advantage that the tool magazine has a corresponding positioning drive by means of which the respective desired tool row can be offered to the machining spindles. The same can be accomplished, of course, by means of the corresponding positioning drive of the spindles.

According to the invention it is, however, alternatively also possible that the tool axis of the tool supplied in the tool magazine is orientated parallel to the plane.

Besides to this angled, in particular rectangular, arrangement with regard to the plane, which may lead to an “upright arrangement” of the tools in the tool magazine, it is possible to position the tools radial on the plane in order to provide with tools, for example, several machining spindles, the spindle axes of which are arranged with a certain angle to each other.

Here the invention is suitable to be used in machine tools with several machining spindles, the axes of which are orientated either parallel or angled to each other, preferably rectangular and so on.

In order to solve the problem formulated in the beginning the invention comes from machine tools as described in the beginning and suggests that the tool magazine is held by a supporting beam which penetrates the tool magazine.

In the known constructions the tool magazine is suspended for example from a free collar beam. This leads to the fact that precious working room is sacrificed for the fastening and the connection of the tool magazine and for the movement of the tool magazine. This disadvantage in the state of the art is solved in a very elegant way in the invention, namely by penetrating the tool magazine by the supporting beam and therefore by placing in the average at least a part (for example between 25% and 75%) of the required tools above the supporting construction, which is needed anyway, and therefore not in close distance to the working room. Here, of course, the tool magazine is designed in such a way that these tools not required can be brought into a changing position in a quick way. Such a drive, however, is also needed in the state of the art.

Simultaneously, however, it is possible by means of the design of the invention to support the supporting beam in such a way that it serves for increasing the stability of the complete machine tools. The supporting beam can be positioned in such a way that it does not take the mass of the tool magazine in a free collar way. Basically, it is possible here to select the support of the support beam in such a way that it does not obstruct in the region of the working room.

By means of the proposed measurements the invention accomplishes a more efficient use and simultaneously a better access of the working room.

In a preferred embodiment of the invention it is provided that the tool magazine has a supporting beam part which can be put into the supporting beam. It is planned here that the machine tools is designed in a way that it can be pre-assembled and as a modular structural component which comprises all elements needed for the use of the tool magazine (magazine drive, axis of movement). For resetting purposes here it is convenient to design the complete machine tools structural component in such a way that it can be exchanged for another one in order to keep the set-up times at the machine tools as low as possible. The tool magazine here has a supporting beam part which can be put into the supporting beam which has the corresponding intersecting points (for example mechanic or electric).

It is an advantage if the magazine has a recess in the region of the penetration of the supporting beam. It is, for example, provided that the recess is larger than the diameter of the beam additionally the way of the cylinder for positioning the tool magazine with regard to the machining spindle. In order to design the magazine in a way that it can be pre-assembled and simply to exchange, the supporting beam is equipped in front of and behind the magazine with an intersection point and designed as supporting beam part.

Furthermore it is an advantage in a variant of the invention if the tool magazine has a motion drive, for example a working cylinder, which allows the movement of the tool magazine essentially rectangular to the extension of the supporting beam using of the recess. This movement of the tool magazine is necessary then when a corresponding movement axis of the machining spindle, respectively of the machining unit, is not available. By means of this drive it is possible to position the tool magazine for the changing procedure in the range of the machining spindle. Here the invention does not restrict the tool magazine to a position above, below or on the side of the machining spindle. Of course, it is also possible that the machining spindle, respectively the -machining unit, as well as the tool magazine have a parallel extending drive each.

Conveniently a working cylinder is used as motion drive. This is, for example, an hydraulic cylinder, however, it is also possible to design the working cylinder pneumatic, for example as counter weight cylinder. However, also electromechanic drives, for example electromotor and ball roller spindle and so on, can be used.

In this connection it is an advantage that the tool magazine is designed in such a way that it can move against the machining spindles. Besides the above mentioned measurement where the supporting beam penetrates the tool magazine it is, of course, also possible to select another arrangement where the tool magazine is supported in another way, however, it is nevertheless designed in such a way that it can move, in particular be positioned in a controlled way, with regard to the machining spindles in order to, for example, position it.

Alternatively to the variants according to the invention described above where the supporting beam penetrates the tool magazine, it is provided in another variant of the invention that the tool magazine is held by a supporting beam which extends essentially rectangular to the axis of the machining spindle. Thus, for example, a disc-shaped tool magazine held on the supporting beam extends, if necessary in a plane which is rectangular to the tool spindle axis. Basically such an arrangement of the tool magazine reaches already several machining spindles arranged side by side.

Conveniently the invention furthermore proposes that the supporting beam forms a crosshead between the columns which itself has means for receiving the workpiece. The machine tools are designed like a column. On the main columns there are the guides for receiving the workpiece. On these columns a crosshead for connecting of the two columns is arranged. This crosshead first of all serves for strutting the columns among themselves and thus the machine tools altogether. Simultaneously it is convenient that this crosshead also forms the supporting beam which carries the tool magazine. By means of that the tool magazine is positioned in direct neighbourhood of the working room and uses in a smart way also the machine stand. It is an advantage here if the tool magazine, for example if it is shaped, for example, like a disc, is arranged rectangular to the axes of the machining spindle. By means of that a collision is avoided. Simultaneously one tool magazine serves for a multitude of spindles, respectively a smaller number of tool magazines has to be supplied than there are machining spindles.

According to the invention it is provided that the tool magazine has a magazine door which is open in the case of the tool change. Usually the tool magazine is built in a housing in order to avoid a soiling of the tools, respectively of the tool receiver, by particles otherwise flying around like chips and so on, which could prevent the tool from secure and reliable clamping on the machining spindle. For the changing procedure where the tool which has to be changed is no more machining the magazine door is opened. The magazine door here is located below the magazine and above the working room (under the condition that the magazine is above the working room, respectively the machining spindle). For the opening movement of the magazine door now the next invention is proposed that the opening movement of the magazine door is deviated from the movement of the tool magazine on the supporting beam.

This development according to the invention saves the otherwise known hydraulic door drives. A separate valve, a working cylinder, a metallic tissue absorber, a limit switch, electronic for the switch interrogation and so on are not necessary anymore. By means of the basically mechanic embodiment (this can be carried out by means of a belt drive or lever mechanics) a simple, economic and reliable solution is suggested. In addition to that this solution also implies a high person security as the magazine door is moved simultaneously by an axis monitored by the control, which is person safe anyway. Therefore also the change of tool can be allowed when the safety door of the machine tools is open. It is possible here to realise any width of doors as the requirement for a larger working cylinder, which is needed anyway for the movement of the tool magazine on the supporting beam, is not relevant here.

The invention reserves the seeking of protection for the object mentioned before, if necessary, independently and detached of the other ideas.

Here also according to the invention machine tools are proposed wherein for the in particular cutting machining of work pieces several machining spindles are provided. A tool magazine serves here for supplying and changing of the tools of at least two machining spindles.

It is known in the state of the art that with multiple spindle machine tools one magazine each per spindle has been provided. This leads to a correspondingly large number of tool magazines in the range of the spindle. That means that the working room, which is limited anyway, is further narrowed by the high number of tool magazines.

In particular it is proposed in the variant according to the invention that the tool magazine is designed as a chain magazine and the chain can circulate endlessly and the chain carries tool tongs for picking up the tools. The use of chain magazines as tool magazines is known in the state of the art. Alternatively to that it is also known to design the tool magazine as disc magazine. It is in particular possible to equip the tool magazine with a ring-shaped disc wherein the disc carries on its outsides tool tongs for picking up the tools.

The ring-shaped design allows in a simple way to realise a rotatable disc around the supporting beam. In the same way it is, of course, also possible to design an endlessly circulating chain magazine which encloses the supporting beam and is penetrated by it. The applicant reserves the seeking of independent protection for this object detached from the special arrangement of the supporting beam which penetrates the tool magazine.

The invention, on the other hand, actually unites in the two proposals considerable advantages, because exactly then these two proposals working even separately, for example with multiple spindles applications, lead to a considerable saving of space in the working room.

Furthermore it is provided according to the invention that the circulating chain of the chain magazine or the disc determines the plane. Usually the disc is designed plane and therefore determines the plane. The chain of a chain magazine is guided along a guide, wherein, as a rule, the guide also determines the plane. The invention can naturally also be applied on such systems where the chain can move in such a way that the chain can move in several planes, however, in this case the term plane has to be understood in the respect that at least the tools supplied in the range of the spindles as well as the tools which have to be changed are at the same plane even if the other supplied tools are in another plane, if necessary parallel to the first one in the range of the plane defined by the tool spindles. This solution is also enclosed by the suggestion according to the invention.

In this connection the invention also proposes that if the embodiment of the tool magazine is ring-shaped a second or more rows of tools are arranged on the ring. Of course, it is also possible to design the tool magazine as a disc.

In another embodiment of the invention it is provided that the (ring-like) disc is shaped on its outside circular or polygonal.

Actually the polygonal embodiment of the disc is an advantage in a use of the tool magazine for multiple spindle machining units because the tools are offered in the way they are picked up by the machining spindles.

It is advantageous if the distance of the tongs corresponds with the distance of the spindles. Here in each case the center distance is relevant, that means the respective axis measurement is equal to each other. Such an embodiment of the invention is possible, for example, with a chain magazine wherein the respective chain pitch corresponds with the distance of the machining spindle. However, this is also possible with a disc equipped as a tool magazine. In this case on each side of the n-angled disc the same amount of tongs as spindles or m sets with k tongs are arranged in a straight line side by side. Either all k tools are then picked up by the k spindles or the spindle, respectively the tool magazine, is cycled on accordingly to the next free or occupied tongs for deposition or picking up of a workpiece. For example, an arrangement of the tools 1111-2222-3333 results, same numbers meaning parallel use of the tools on the respective machining spindles.

Alternatively to that it is also possible that the distance of the spindle is an integral multiple of the distance of the tongs. In this case the tongs sets (and connected with that also the corresponding tool sets) are arranged alternately. For example, the tools are arranged as follows: 1-2-3, 1-2-3 and so on. The advantage of this design is that only a small relative movement between the first tool tongs and the tool spindle has to be carried out in order to offer a second tool set. This can be done in a short period of time.

In another variant according to the invention it is suggested that the distance of the machining spindle is variable. This is, for example, convenient if another tool magazine has been built in which has, for example, a higher density of tools and the average distance between the tool tongs is smaller. This leads to a reduction of the average distance of the spindles. In order to be able to carry out in particular a simultaneous change of tools it is convenient to design the distance of the machining spindle variable. This can be carried out for example by a corresponding manual or even an automatic control. For example, in such a variant an adjustment drive is provided by means of which the distance of the machining spindles can be varied. If necessary this is done automatically, for example by means of a corresponding data exchange, namely if the control recognises the type of the built-in tool magazine and, because of the type, takes out the tongs distance from the data bank and guides this information to the control for the adjustment drive of the machining spindles.

In the sense of the invention it has the same significance whether the distance between two machining spindles of the same machining unit or the distance of the machining spindles of two different machining units is changed. The possibility of varying the distance of the machining spindles is not only an advantage when the tools are changed, respectively the tool magazines are changed, but it is also used for the machining itself. Because, if it is found, that different series have to be produced in the machine tools according to the invention, it is possible by means of a variation of the distance of the machining spindles to adjust these to the different series on a short notice. By means of that it is achieved that even with smaller series a higher cutting performance is reached without expensive set-up works. The result from that is that it is convenient that the distance of the machining spindles during the machining and/or during the tool change is varied. Usually it may result that the spindles can move to each other in X-direction and therefore the machining spindle distance can be varied. Naturally it is convenient that this drive can also be used during the machining for machining purposes.

It is provided that the distance of the machining spindles can be varied during the machining and the machining spindles can be brought into a tool change distance for the tool change. The tool change distance is here for example determined by means of the design of the tool magazine and the arrangement of the tools on this magazine. Eventually the machine tools are completely free with regard to the actual arrangement of the tools in the tool magazine. It allows a high degree of application possibilities on the workpiece and is, nevertheless, able to carry out even comparatively complex tool change operations simultaneously in a way that saves space.

It is actually the use of the X-drive during the machining which leads to another machining axis which is, for example, used double for the changing procedure.

Machine tools according to the invention have already a higher cutting performance because of the multiple spindles. By means of the higher cutting performance also the dwell time of the workpiece in the machine tools or in a machining line comprising the machine tools according to the invention, a transfer line or interlinked arrangement is lowered accordingly. Decisive for the capacity of machine tools, but also even for more complex machining lines, are not only directly the cutting or chip performances but also dead times as short as possible, for example during the change and exchange of a workpiece, respectively the set-up of the tools. The invention achieves a considerable time advantage if the tool change is carried out on at least two machining spindles simultaneously. By means of this suggestion according to the invention the set-up times are reduced considerably and the efficiency, respectively the performance, of the machine tools is increased accordingly.

By means of the possibility of adjusting the distance of the spindles this advantage acts, independently from the concrete embodiment of the tongs distance, on the tool magazine. The flexibility of such machine tools according to the invention increases considerably.

Conveniently the machining spindle is located here in a machining unit in a guide in such a way that the distance between the machining spindles can vary.

Besides the possibility to vary the distance of the machining spindles it is, according to the invention, also possible, to vary the distance of the tongs to each other. Therefore it is possible to use different tool magazines variably in different machine tools equipped according to the invention and to adjust it by means of a change of the respective distance of the tongs to adjust it to the respective specific distances of the machining spindles.

It is very convenient if the tongs are supported movably in a linear guide and a tongs adjustment drive modifies the distance from the tongs to each other. By means of that it is basically possible that even the tongs distance can be changed automatically for example via the control.

### BRIEF DESCRIPTION OF THE DIFFERENT VIEWS OF THE DRAWINGS

Further embodiments according to the invention are described in the sub-claims. The invention is shown diagrammatically in the drawing. In the figures:

FIG. 1 In a three dimensional view the machine tools according to the invention;

FIG. 2 a front view according to FIG. 1;

FIGS. 3, 4, 5, 6, 7, 8, several details of the tool 9, 10, 11, 12, 13, magazine of the machine tools 14 and 18 according to the invention, each in a view;

FIGS. 15, 16, 17 details of the tool magazine door drive of the machine tools according to the invention in a view;

FIG. 19 in another three dimensional view the machine tools according to the invention;

FIG. 20 a top view of another variant of the invention and

FIG. 21 a back view according to FIG. 20.

### DETAILED DESCRIPTION OF THE PREFERRED EMBODIMENT

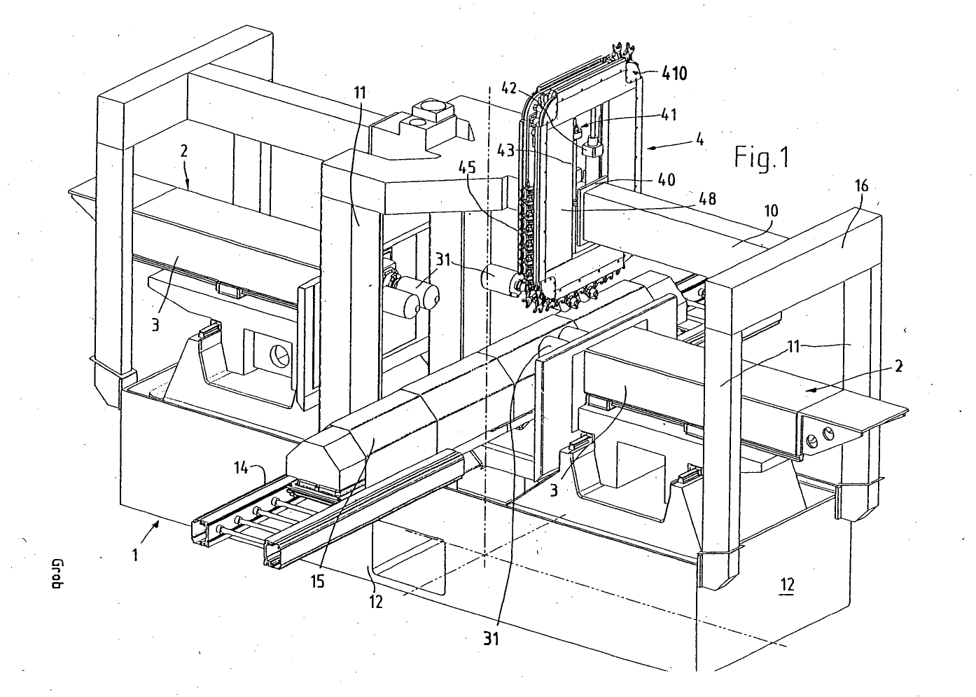

In FIG. 1 the machine tools according to the invention are shown schematically. The work pieces which have to be machined on are on the conveying line 14. They are, hidden by a chip protection tunnel 15, for example on a passage through these machine tools. For a better view the workpiece which has to be machined on is not shown.

Reference number 2 is a machining unit each. The machining units extend in this example on both sides on different sides of the conveying line 14. The workpiece which has to be machined would be located between the two machining units 2.

Each of these machining units has in the example shown here two machining spindles 3. These are hidden in the embodiment shown here by the housing of the machining unit 2.

The complete machine tools are supported by a machine bed 12. The machine bed extends here on both sides of the conveying line 14. The machine bed has several columns 11 which rise above the machining units. The columns 11 carry a supporting beam 10 over the crosshead 16. The supporting beam 10 here is eventually supported on both sides of the conveying line by the columns 11 and struts the machine tools according to the invention.

The supporting beam 10 carries the tool magazine 4. It can be seen easily that the supporting beam 10 penetrates the tool magazine. It is also easy to see that a part of the tools 31 is supplied in the tool magazine 4 below the supporting beam 10, and another part of the tools 31 is supplied above the supporting beam 10. The supporting 10 is here essentially parallel to the spindle axis 30 of the machining spindle 3. This leads to simple constructive facts because the respective movements to each other are carried out rectangular.

By means of that it is achieved that in the working room 13 where the tool spindle acts on the workpiece only the actually necessary tools are supplied for a tool change. Other tools are, because of the movement of the tool magazine, dislocated upstairs and are moved in according to the demand.

The embodiment in FIG. 1 shows a tool magazine which is designed as chain magazine 45. A chain 405 circulates endless on a frame essentially rectangular.

It is convenient here that the supporting beam 10 serves for strutting the machine tools 1. Here, for example, the supporting beam 10 is supported by the columns 11 which also serve for guiding the workpiece sledge 17. This in particular advantageous when on both sides of the conveying belt, respectively of these columns, machining units are provided, because here the columns must have a comparatively filigree design because of a sufficient access for the machining. In this case also the supporting beam 10 struts the machine.

According to the invention it is provided that at least a part of the supplied tools 31 and the tools 31 which have to be changed are arranged in one plane 410.

In the design of the tool magazine 4 as a chain magazine 45 shown in FIG. 1 the plane 410 is defined by the guide line of the tool chain. In the embodiment of the tool magazine 4 shown in FIG. 1 here the chain magazine 45 is constructed essentially rectangular. However, any other geometry may be used. The edges of the rectangle here a part of the plane 410. The advantage of the embodiment as chain magazine 45 in the variant according to the invention is the fact the tools 31 which have to be changed for several spindles 3 in a corresponding straight arrangement of the respective guide line of the chain magazine 45 are arranged automatically already parallel one beside the other in the plane 410 and offered to the tool spindle.

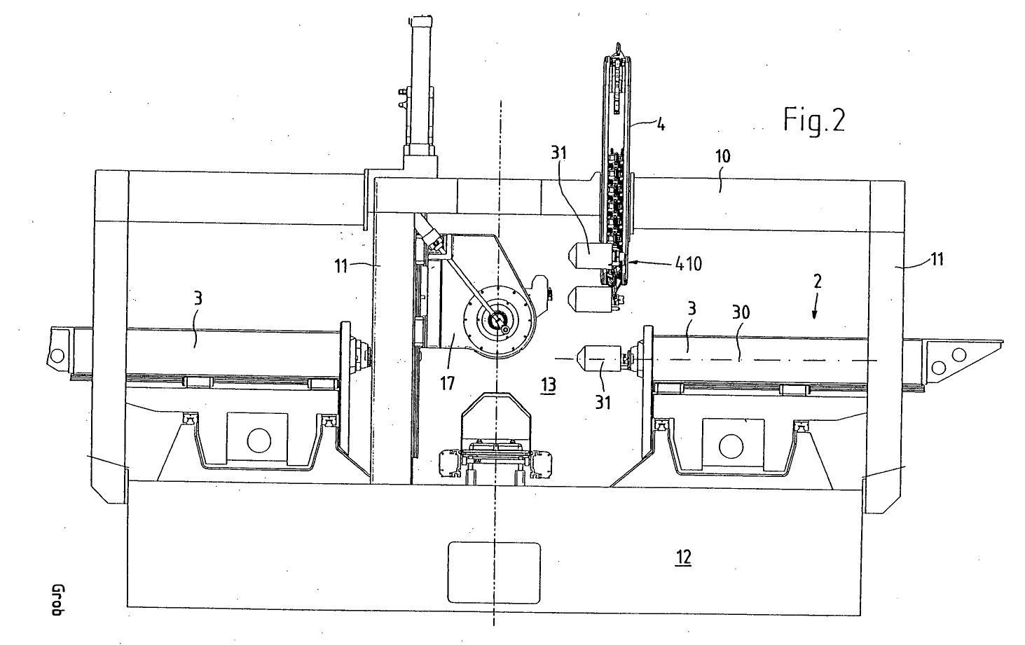

In particular in FIG. 2 it can be seen clearly that the supporting beam 10 extends above the machining unit 2. Alternatively it is also possible to arrange the supporting beam laterally near the machining unit, respectively the machining spindle. The arrangement above the conveying line 14 is convenient as by means of that the supporting beam does not collide with the conveying line and there is usually sufficient space above the machines. It is also an advantage here that the supporting beam 10 also bridges the working room 13. In this case the supporting beam is supported by the columns 11 which are arranged with regard to the conveying line 14 on the opposite side, the tool magazine being arranged on the other (right hand) side (in FIG. 2). It can be seen clearly that the plane 410 is in this example shifted a bit to the left towards the tools 31 used in the machining spindle 3. In this side view several tool spindles 3 are located on the right hand side one behind the other and define therefore a connection line which is, in this case, not part of the plane 410, but is parallel to it. Here the tools 31 which yet have to be changed also count to the plane 410 as long as they are in the tool magazine. This arrangement can be used with a disc- or ring-shaped tool magazine 4, as well as with a chain magazine 45.

Furthermore it is an advantage that the tool magazine 4 can be lowered vertically. Such an embodiment is an advantage when, as in the example shown here, the machining unit, respectively the tool spindle, does not have a vertical actuating drive. In the example shown here this is performed by the workpiece sledge 17. In order to bring the tools 31, which have to be changed, into the range of the machining spindle 3 it is convenient here to lower the tool magazine 4.

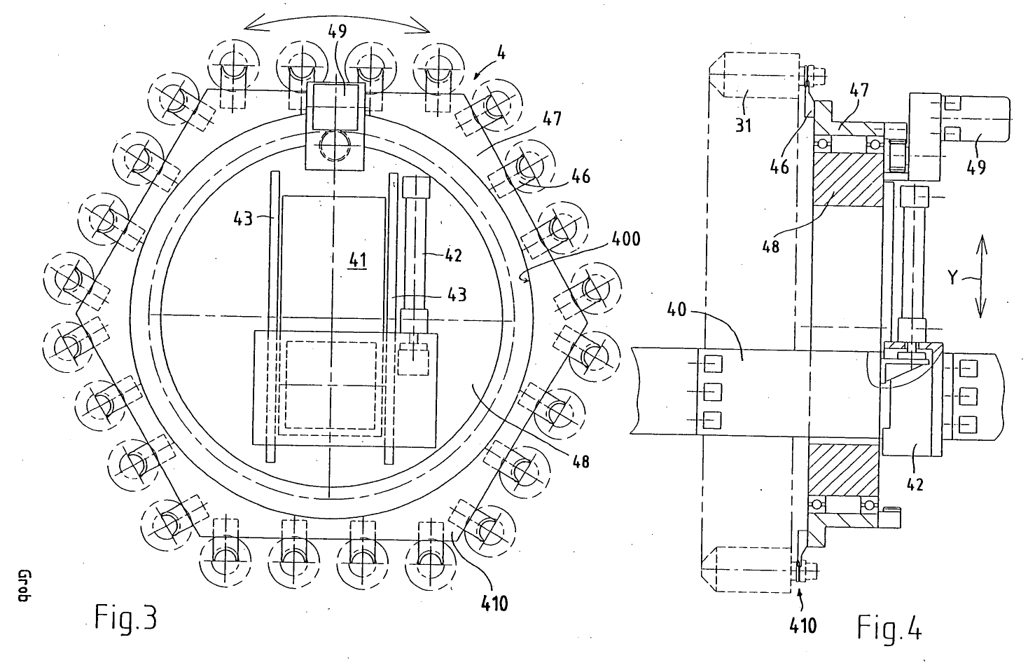

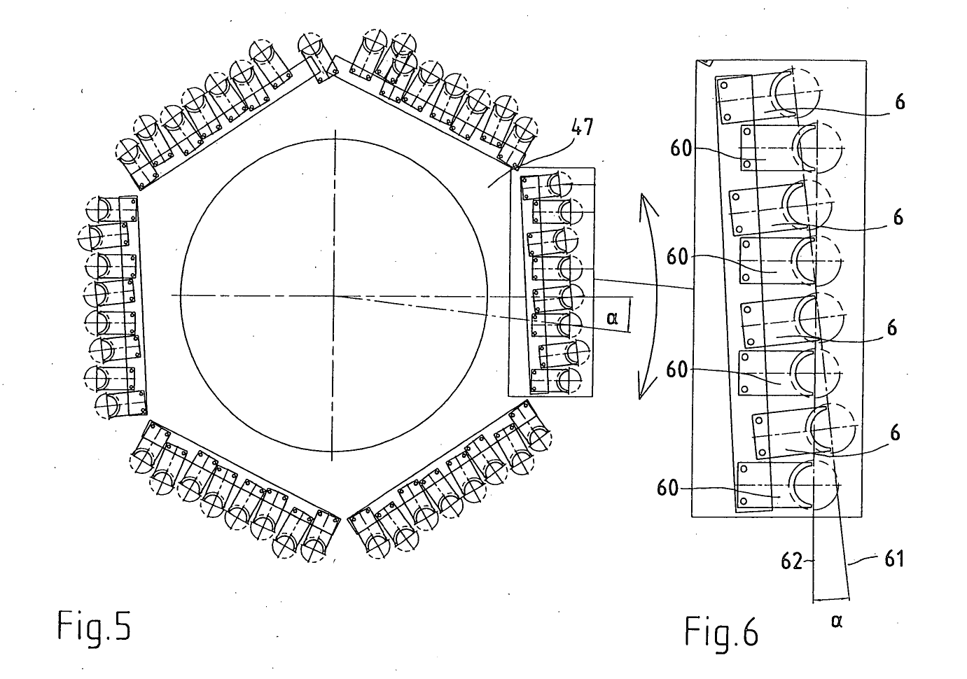

The special construction of a tool magazine according to the invention is illustrated basically by means of the FIG. 3 and 4. FIG. 3 shows here in a view a tool magazine 47 designed as a disc-like ring which is, however, with regard to the connection to the supporting beam 10, is designed in the same way as the chain magazine shown in FIG. 1.

In FIG. 3, respectively FIG. 4, the plane 410 is defined by the ring-shaped design of the tool magazine 4.

In FIG. 4 a side view, partly as a section, is shown. The tool magazine 4 is designed as a module and allows a quick exchange in the machine tools. As, according to the invention, it is suggested to have the tool magazine 4 penetrated by the supporting beam 10, advantageously the tool magazine 4 is realised in such a way that it has a releasable supporting beam part 40 which can be set at corresponding intersecting points in the supporting beam 10.

The tool magazine has a receiver 48. This does not move with regard to the tool tongs 46 receiving the tools and therefore is a stationary mounting surface which may be used, for example, for mounting on tool checking devices, magazine tongs operating devices and so on.

The receiver 48 has a recess 41 which is limited on the sides by guides 43. The supporting beam part 40, which closes an otherwise provided gap in the supporting beam 10, can move along this guide 43 in the recess 41. Conversely, this means that the receiver 48 can move with regard to the supporting beam 10. For that purpose a linear motion drive 42 is provided. The motion drive 42 is, for example, an hydraulic or pneumatic cylinder, however, even a mechanic drive may be provided. By means of this motion drive 42 it is achieved that the tool magazine 4 can be lowered in the range of the spindle 3 for changing the tools 31. The ring-shaped disc 47 is supported rotatable around the not-rotating receiver 48 (FIG. 4). The ring-shaped disc 47 carries the tools 31 over tool tongs 46.

The solution mentioned before allows a very space-saving arrangement of a large number of tools 31 close to the working room 13.

It is an advantage that the machine tools 1 has at least two machining units 2. These allow a variable machining of the workpiece. It is, in particular, convenient here that the machining units 2 machine on the workpiece from different sides, as it is, for example, shown in FIG. 1, respectively in FIG. 2.

In this connection it is an advantage that the tool magazine can traverse on the supporting beam. Therefore it is basically possible that the tool magazine serves for changing the tools of the machining spindle of several machining units. In this example thus the tool magazine provides two machining units with, if necessary, differently orientated spindles, which is compensated, however, by means of the tool magazine, respectively the tongs provided there, in a simple manner when these are able to grip the tools in two directions.

Similarly to the solution according to the invention that one tool magazine serves for supplying and changing the tools of at least two machining spindles, also the solution mentioned above serves for an effective use of the narrow space at or in the working room.

In another preferred embodiment of the invention it is provided that at the receiver 48 a drive 49 is arranged for the tool magazine 4, in particular a chain drive or a rotational drive for the disc 47. This drive 49 serves for transporting the respective necessary tools 31 for exchanging or empty spaces for exchanging of tools not needed anymore to the machining spindle.

In particular the solution with a ring-shaped disc (either circular or polygonal) leads in a simple way to a simple transmission. The ring-shaped disc 47 has here on its inside 400 a toothed ring and the toothed ring co-operates with the pinion of the rotational drive 49.

For receiving the tools 31 tool tongs 46 are arranged at the edge of the disc 47 with a corresponding distance. The distance of the tongs 46 is selected here in such a way that it corresponds with the distance of the spindles 3.

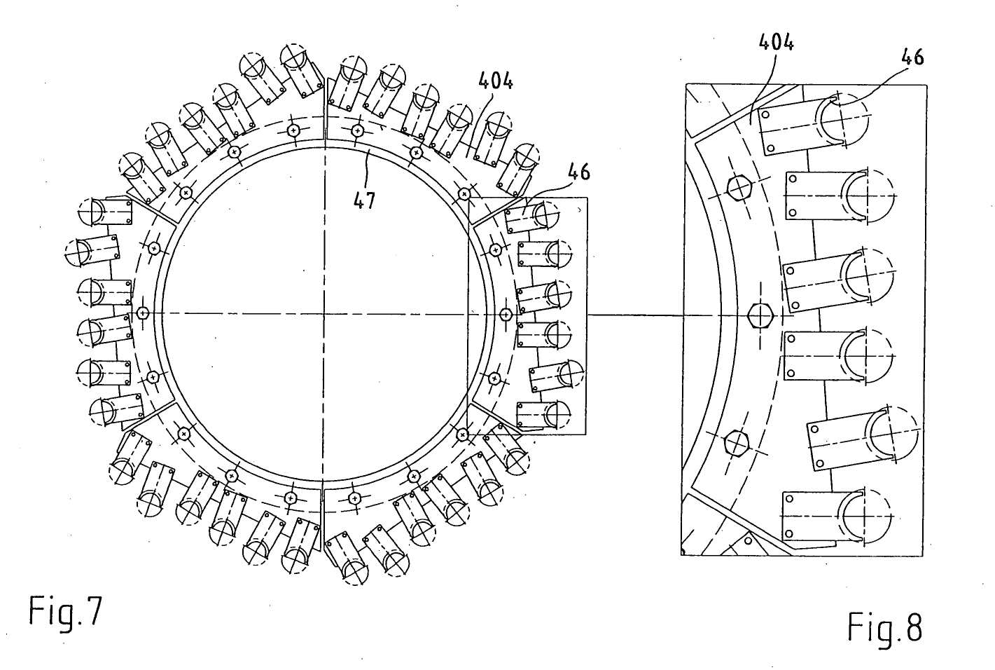

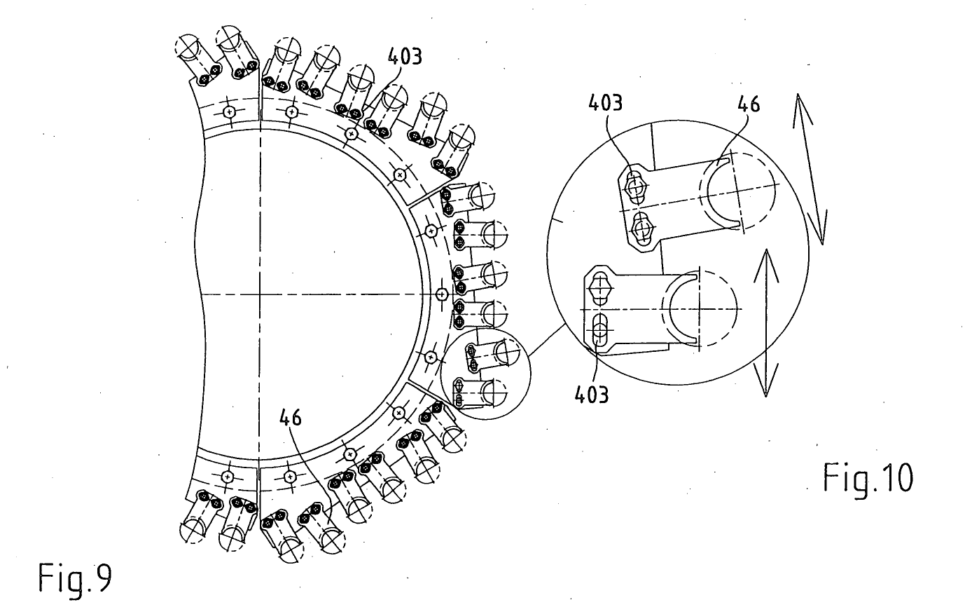

In FIG. 5, 6 an advantageous variant of the embodiment of a tool magazine according to the invention is shown. On first sight the tool tongs 46 on this disc 47 shaped as a hexagon do not seem to have any order. But actually they are orientated to each other in a very intelligent and effective way. This becomes clear in the enlargement shown as FIG. 6.

On each one of the sides of the hexagon shown in FIG. 5 eight tool tongs each are arranged. These are subdivided into two sets of tongs 6, 60. The first set of tongs 6 differs from the second set of tongs 60 in such a way that the front edges of the respective tongs belonging to one set of tongs are on a common tongs line 61, 62. The assignment of the different tongs to the respective sets of tongs is meant alternately in such a way that the first tongs are assigned to tongs set one, the second tongs to tongs set two, the third tongs to tongs set one and so on.

The procedure is now as follows. When the tool spindles have put back the first four tools in the first tongs set 6, the discs 47 cycle on around the angle alpha, which is between the first and the second tongs line 61, 62, to the second set of tongs 60. Then the machining spindles are loaded with the second set of tongs 60. Until the next change the disc will cycle around a larger angle to another side of the hexagon. This cycling is carried out, for example, during the machining and therefore does not need additional time.

The advantage of this embodiment is that simultaneously for a larger number of spindles in a short period of time the respective necessary tool can be exchanged. The example shown in FIG. 5 shows 2×4 tongs. However it is also possible to collect k tongs each in a tongs set, k being an integral number.

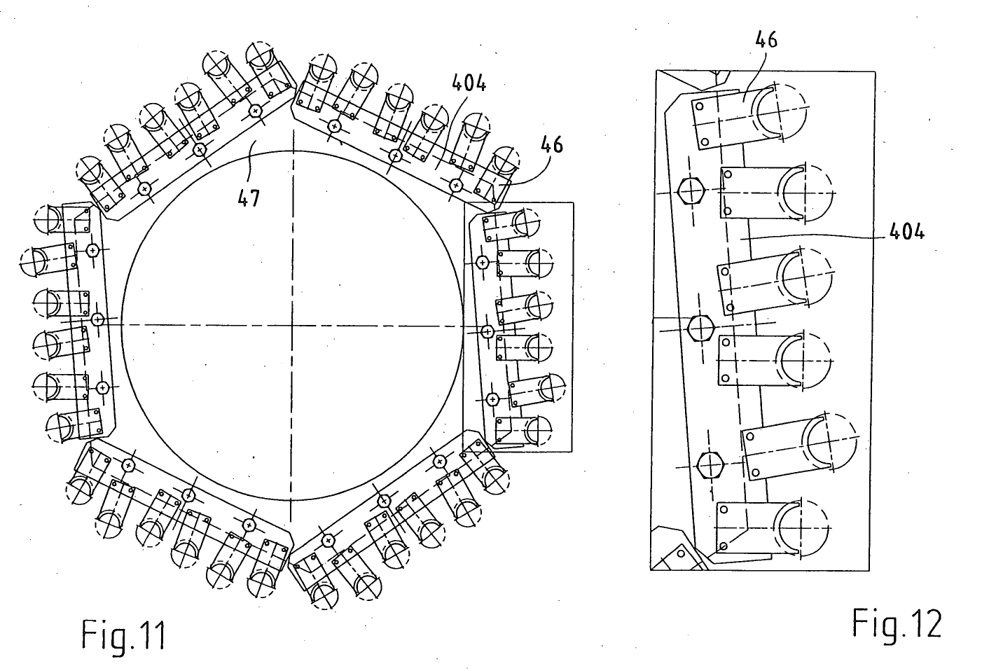

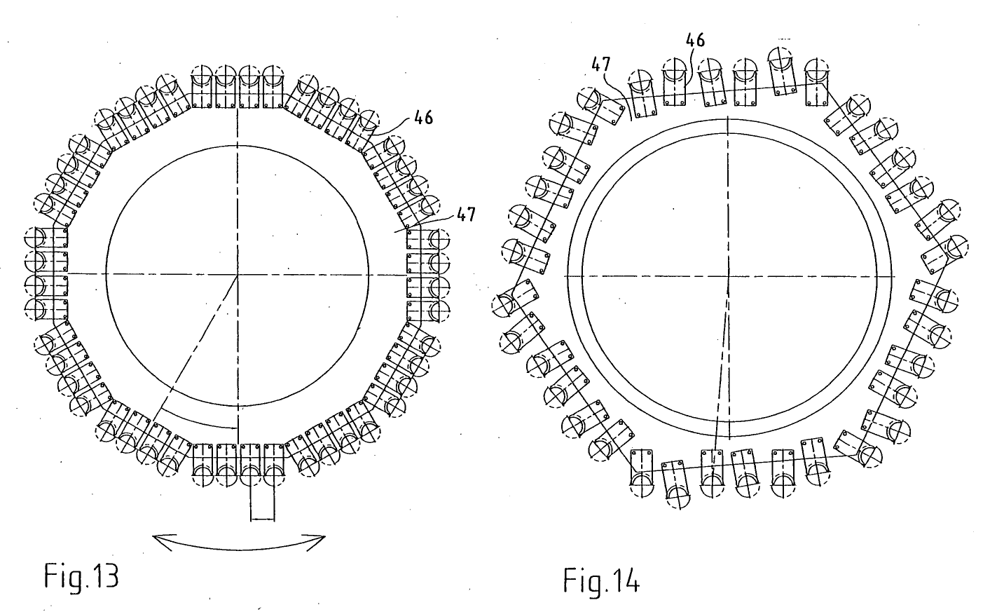

In FIG. 7, 8 another variant of the invention is shown. Here also FIG. 8 means an enlargement of a detail according to FIG. 7. In this example tongs slabs 404 are provided which carry one or more tongs 46, respectively tongs sets 6, 60, the tongs slab 404 being connectable as a whole with the disc 47. Here the slab 404 is fastened with screws and nuts on the disc 47. This development according to the invention allows an easy and simpler exchange of a larger number of tongs or complete sets of tongs. For a certain adjustment possibility it is convenient if the tongs 46 are guided and held in longitudinal wholes 403. This is, for example, shown in FIG. 9, 10, also FIG. 10 being here an enlargement of a part according to FIG. 9. Here the tongs receiver that is the region where the tongs 46 are linked with the disc, has an- elongated whole 403. This allows a certain adjustment possibility of the position of the tongs and accommodation with regard to the distance of the spindles. The elongated wholes here can also be arranged on the disc 47 or the slab 404.

Similar to FIG. 7, 8 also FIG. 11, 12 show the use of a tongs slab for receiving a larger number of tongs 46. The tongs slab chosen in. FIG. 11 is designed more rectangular, on the other hand, the suggestion according to FIG. 7 shows a concave tongs slab 404.

In FIG. 13, 14 two different concepts are indicated for offering of the tools which have to be changed and replaced.

In the example according to FIG. 13 forty eight tools are provided in a dodecagon with four tongs per side. Such an arrangement can be used when an single spindle device reaches four tools each by traversing along the X-axis. Only then a cycling on of the disc becomes necessary. However, alternatively it is also possible to operate a four spindle machine with the example shown here, wherein parallel to each other four tools are offered for exchange or replacement. In this case then the tool has to be cycled on about 30° in order to receive new tools after the tools have been delivered.

In opposition to that the solution according to FIG. 14 proposes thirty six tool tongs which are arranged orientated on a hexagon and are arranged in groups per side in two tongs sets each positioned angled to each other. The arrangement corresponds here with the one carried out in FIG. 5 or 6.

FIG. 18 shows a possibility to modify the tongs distance in the tool magazine 4 continuously. A section of the magazine disc is shown, for example a side of a hexagon. Four tongs 46 are supported traversably in a linear guide 402. They are connected to each other by means of a threaded drive 401. This threaded drive has either a left-handed or right-handed thread for the different tongs. Here the thread pitch of each of the tongs is different. If the spindle is turned the tongs distance is changed according to the pitch, pitch difference and pitch direction of the threads. It is possible here to adjust the spindle manually or automatically. It can be designed self locking, alternatively the tongs can be jammed in the guide after the adjustment.

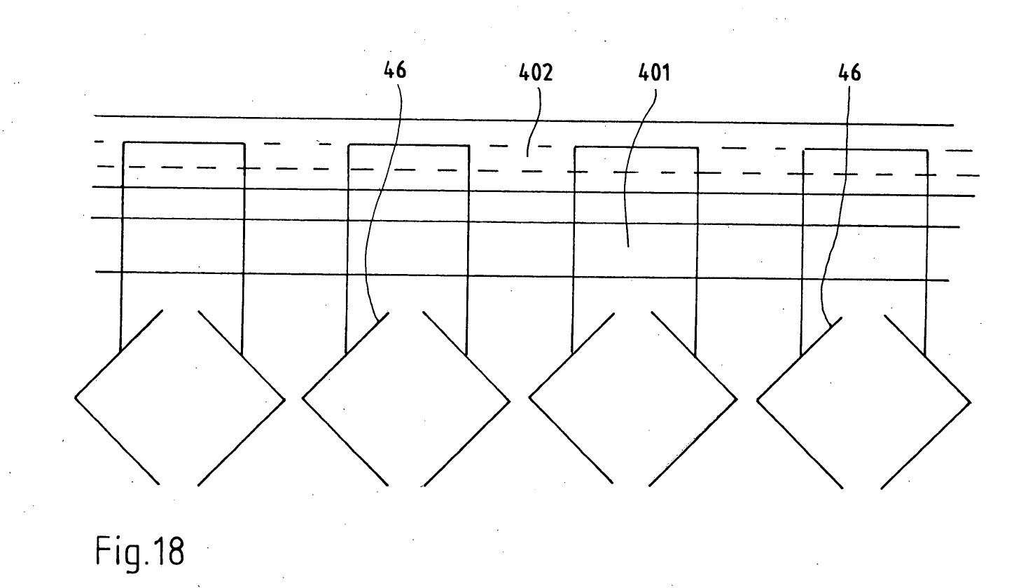

In FIG. 17 a variant is shown how the opening movement of the magazine door 44 is deviated from the movement of the tool magazine 4.

Usually the magazine door 44 is located below the magazine 4 and thus above the working room 13. For that the magazine movement up is elongated beyond the measure which is needed at least, for example, the magazine door 44 is designed as aluminium link conveyor door. The drive of the door is carried out via a pulling means 70. The belt 70 is guided over two rollers 71, 72 which are moved together with the tool magazine 4. An end of the belt is cramped stationary 74, the other one is connected with the tool magazine door 44 designed as a link conveyor. By means of that the belt 73 carries out double of the way of the magazine 4. The tool magazine 4 can pass through the door 44 only when the door is completely open. Therefore the way of the magazine has to be enlarged about half of the opening way of the door. The advantage of this embodiment is that an independent door drive with interrogation device and so on is not necessary here. Furthermore the tool magazine has already reached full speed when it enters the working room 13 of the machine.

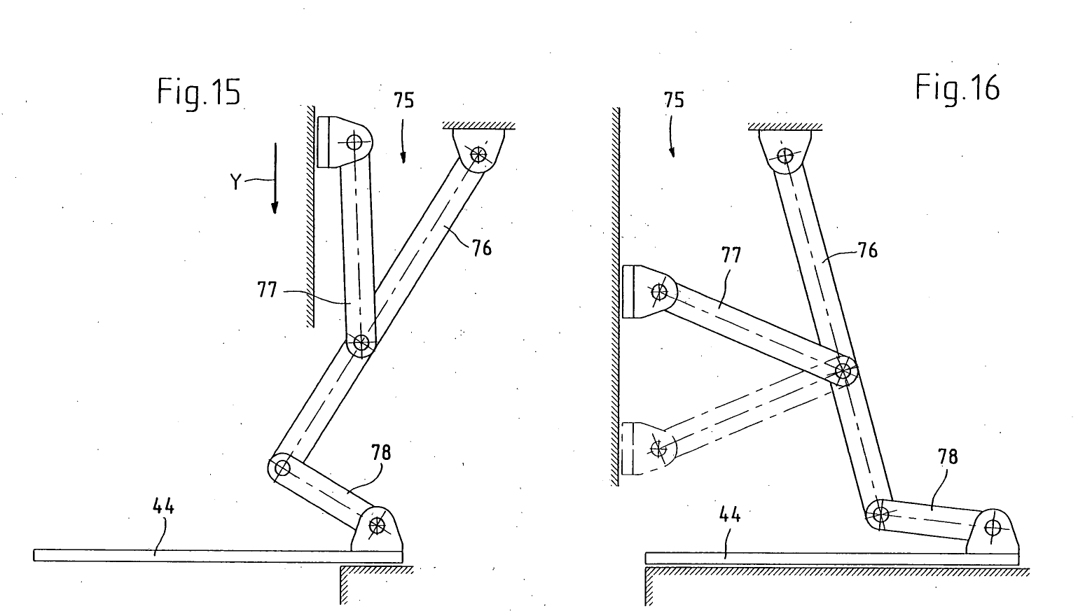

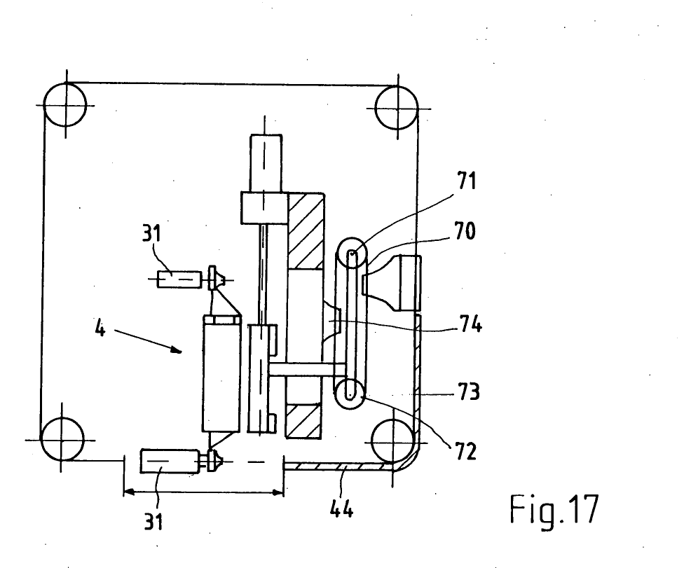

Alternatively to the belt arrangement presented in FIG. 17 the door 44 can also be driven by means of a lifting mechanism (see FIG. 15, 16). The lever mechanism shown in FIG. 15, 16 is designed her in such a way that after half of the magazine way a dead point is reached and the door moves only a little in the second half of the magazine way. By means of that it is possible to design the door in solid tin instead of a link apron and so on. In FIG. 15 the closed magazine door 44 is shown, in FIG. 16 the open magazine door is shown.

The leverage mechanism 75 shown in FIG. 15, 16 comprises three levers 76, 77 and 78. The lever 78 is connected with the door 44 and is flexibly connected with the lever 76 which is supported, for example, stationary. The lever 77, which is connected for example with the tool magazine 4, is joined flexibly with the lever 76. By means of the shown vertical movement (Y-arrow in FIG. 15) the lever 77 is shifted downwards and swivelled anticlockwise. Thus it pulls the lever 76 also anticlockwise. This movement is deviated by means of the lever 78 to the door 44 which is held, for example, in a guide and carries out a linear movement to the right hand side for opening. Therefore an opening movement for the tool magazine door 44 can be deviated cleverly from the vertical movement Y of the tool magazine 4.

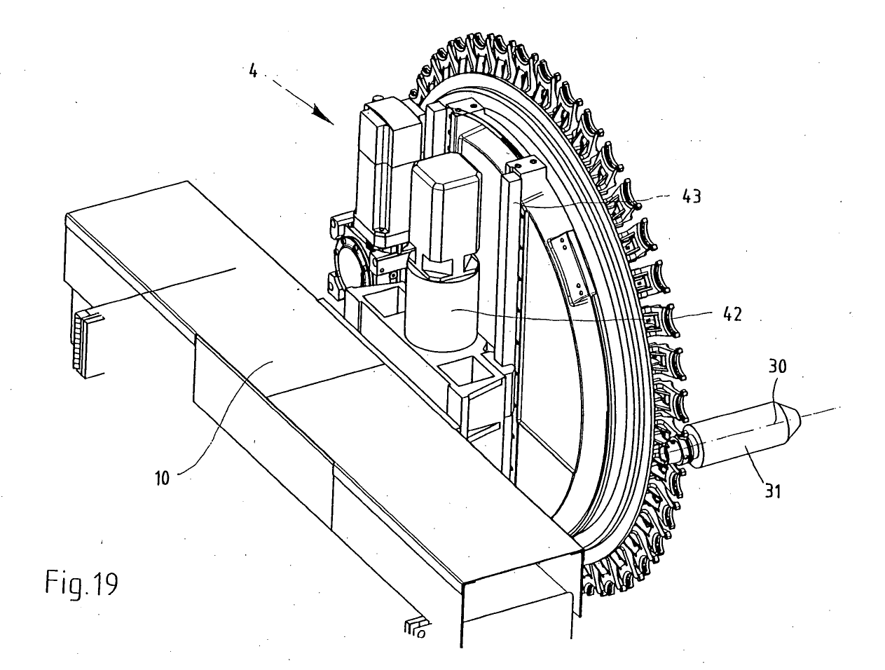

In FIG. 19 a variant for the invention according to FIG. 1 is shown. In FIG. 1 the supporting beam 10 penetrates the tool magazine 4. In FIG. 19 the tool magazine extends essentially parallel to the supporting beam. The supporting beam 10 does not penetrate the tool magazine. The spindle axis 30 is indicated schematically in the tool 31. It extends essentially rectangular to the supporting beam 10. The supporting beam 10, on the other hand, is part of the machine stand and is located, for example, between two columns 11 which themselves carry the workpiece sledge 17.

The arrangement shown in FIG. 19 is in particular advantageous because, by means of that, the tool magazine can be offered simultaneously to several machining spindles arranged parallel to the axis 31 in order to change the tool.

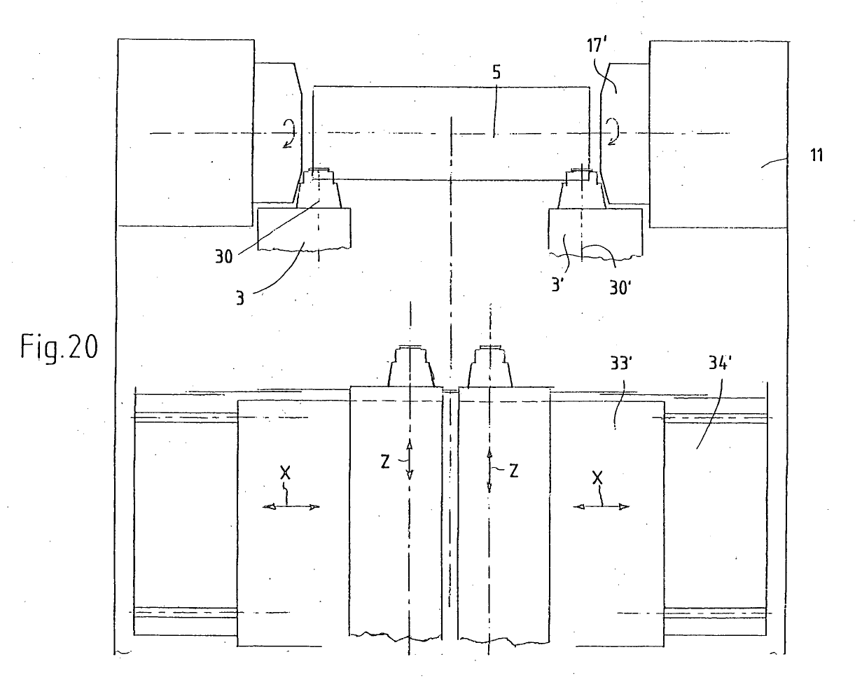

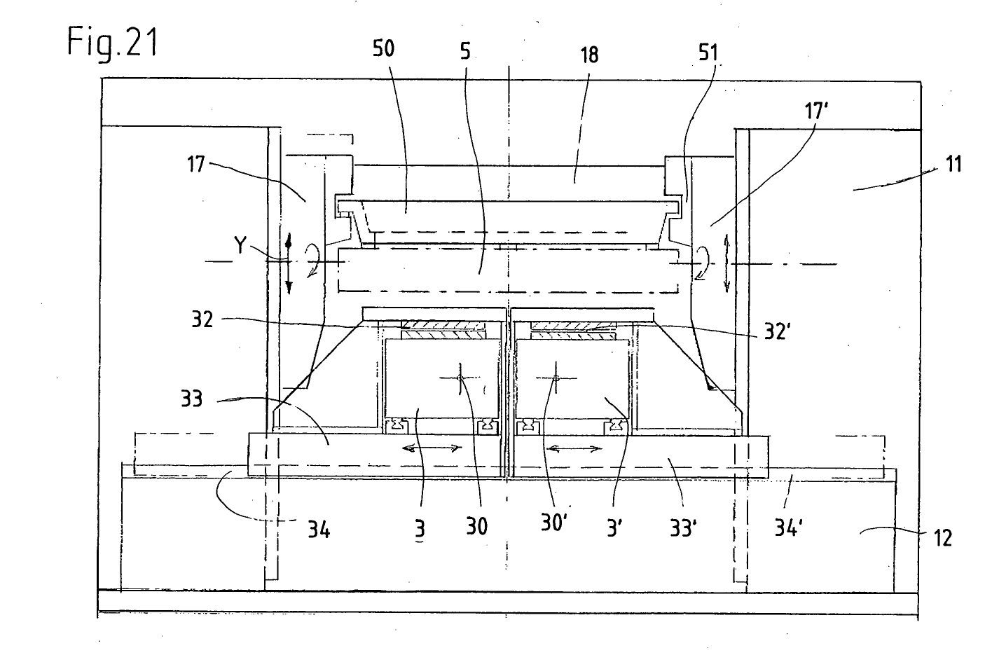

In another variant of the invention it is provided that the machine tools 1 comprise a workpiece carrier 50 for receiving the work pieces 5, the workpiece carrier 50 carrying two or more, if necessary similar or different, work pieces. Such an arrangement is shown for example in FIG. 21. The workpiece carrier is clamped in the workroom 13 by a clamping device 51 which is arranged on the workpiece sledge 17. It is now possible that one or more work pieces 5 are clamped on the workpiece carrier 50. This is shown in FIG. 20.

The machine tools according to the invention shown here show two machining spindles 3, 3′. The distance between the two machining spindles 3, 3′ can be modified. For that the machining spindle 3 is, first of all, supported movably in a sleeve in Z-axis and the sleeve itself is arranged on a sledge 33, 33′, the sledge 33, 33′ being traversable on guides 34, 34′ rectangular to the spindle axis 30. The arrangement is driven by drives 32, 32′, for that purpose for example a linear motor or a ball roller spindle is provided. Here the machining spindle 3, respectively the spindle axis 30, is located between the drive 32 on the hand and the sledge guide arrangement 33, 34 on the other hand. Naturally it is possible to chose another arrangement, for example in such a way that the drive 32 is integrated in the guide.

The arrangement in the machine tools is chosen in such a way here that the two machining spindles 3, 3′ are arranged symmetrically with regard to a center plane. By means of the symmetrical arrangement the space which is available of both machining spindles becomes equal and thus is used optimally even for different fields of applications. In FIG. 20 it can be seen clearly that the asymmetrical arrangement of the machining spindle in the sleeve is suited for reaching even the extreme edge region of the workpiece 5. By means of the symmetrical arrangement both edge regions are reached.

Naturally it is possible to deviate from this symmetry, for example for special machining.

The sledges 33, 33′ can move in X-direction. According to a further embodiment of the invention it is provided that the machining spindle 3 has its own drive 32, 32′ each independent from each other, making the distance between the machining spindles 3, 3′ changeable. Even if the machining spindles are arranged symmetrically, which would for example make a common drive convenient, this variant of the invention allows a high degree of flexibility because a corresponding symmetrical arrangement of the machining points on the workpiece or the work pieces, which may be located together on the workpiece carrier 50, is not important. The sledges 33, 33′ run, if necessary, in a common guide in order to cover in particular the center region optimally and not to form blind spots where a machining is not possible.

In order to increase the stability, a traverse-like connection 18 is provided on the workpiece sledge 17, 17′.

For a flexibility of machining as high as possible it is provided that the workpiece sledges 17 have a circular table through which a horizontally arranged rotational axis is available.

As far as in this application the design and features of the tool tongs 46 have been only described with regard to the embodiment on the disc 47 these embodiments and features also are meant to belong, with regard to the application in a chain magazine, also expressly to the invention and to be disclosed.

In another variant of the invention it is also provided that the disc is shaped as a disc or is shaped as a ring disc.

Although the invention has been described by exact examples which are illustrated in the most extensive detail, it is pointed out that this serves only for illustration and that the invention is not necessarily limited to it because alternative embodiments and methods become clear for experts in view of the disclosure. Accordingly changes can be considered which can be made without departing from the contents of the described invention.

1. Machine tools which have for the in particular cutting machining of workpieces several tool spindles, a tool magazine serving for supplying and changing of tools, the one tool magazine serving for changing the tools of at least two machining spindles, characterized in that at least a part of the supplied tools (31) and the tools (31) which have to be changed are arranged at the same plane (410).

2. Machine tools according to claim 1, characterised in that a connection line between the machining spindles (3) is part of the plane (410).

3. Machine tools according to claim 1, characterized in that the plane (410) for arranging the tools (31) in the tool magazine (4) is orientated essentially vertically.

4. Machine tools according to claim 1, characterized in that the plane (410) for the arrangement of the tools (31) in the tool magazine (4) is orientated essentially horizontally.

5. Machine tools according to claim 1, characterized in that the tool magazine (4) changes simultaneously the tool at several, at least two, tool spindles.

6. Machine tools according to claim 1, characterized in that the tool magazine (4) is designed as chain magazine (45) and the chain can circulate endlessly and the chain carries tool tongs (46) for picking up the tools (31).

7. Machine tools according to claim 1, characterised in that the tool magazine (4) has a disc (47) which carries on its outside tool tongs (46) for picking up the tools (31).

8. Machine tools according to claim 1, characterised in that the tool magazine (4) has a disc (47) which carries on its outside tool tongs (46) for picking up the tools (31) and that the disc (47) is designed ring-shaped.

9. Machine tools according to claim 1, characterized in that the tool magazine (4) has a disc (47) which carries on its outside tool tongs (46) for picking up the tools (31) and the disc (47) is designed on its outside circular or polygonal.

10. Machine tools according to claim 1, characterized in that the tool magazine (4) is designed as chain magazine (45) and the chain can circulate endlessly and the circulating chain of the chain magazine (45) determines the plane.

11. Machine tools according to claim 1, characterised in that the tool magazine (4) has a disc (47) which carries on its outside tool tongs (46) for picking up the tools (31) and the disc (47) determines the plane.

12. Machine tools according to claim 1, characterized in that the spindle axis (30) of the machining spindle (3) is orientated parallel or angled, in particular rectangular to the plane (410).

13. Machine tools according to claim 1, characterized in that the tool axis, in particular the axis of symmetry or rotational axis, of the tool (31) supplied in the tool magazine (4) is orientated parallel or angled, in particular rectangular to the plane (410).

14. Machine tool according to claim 1, characterised in that the tool magazine (4) has a receiver (48) which can be connected with a supporting beam (10), the chain, respectively the disc (47), being movable towards the receiver.

15. Machine tools according to claim 1, characterised in that the tool magazine (4) has a receiver (48) which can be connected with a supporting beam (10), the chain, respectively the disc (47), being movable towards the receiver, and on the receiver (48) a drive (49) for the tool magazine (4), in particular a chain drive or a rotational drive, for the disc (47) is provided.

16. Machine tools according to claim 1, characterised in that the tool magazine (4) has a disc (47) which carries on its outside tool tongs (46) for picking up the tools (31) and the ring-shaped disc (47) has on its inside (400) a toothed ring and the toothed ring co-operates with a pinion of the rotational drive (49).

17. Machine tools according to claim 1, characterized in that the tool magazine (4) has a disc (47) which carries on its outside tool tongs (46) for picking up the tools (31) and the distance of the tongs (46) corresponds with the distance of the machining spindles, if necessary also the machining spindles of different machining units.

18. Machine tools according to claim 1, characterised in that the tool magazine (4) has a disc (47) which carries on its outside tool tongs.(46) for picking up the tools (31) and the distance of the machining spindles (3) is an integral multiple of the tongs distance.

19. Machine tools according to claim 1, characterised in that the distance of the machining spindles (3) can be varied.

20. Machine tools according to claim 1, characterised in that the distance of the machining spindles (3) is varied during the machining and/or during the workpiece change.

21. Machine tools according to claim 1, characterised in that the distance of the machining spindles (3) can be varied during the machining and the machining spindles can be brought into a tool change distance for the tool change.

22. Machine tools according to claim 1, characterised in that an adjustment drive is provided, by means of which the distance of the machining spindles (3) can be set.

23. Machine tools according to claim 1, characterised in that the machining spindles (3) of at least one machining unit are supported by one or more guide(s) in such a way that the distance between the machining spindles (3) can be altered.

24. Machine tools according to claim 1, characterised in that the machine tools have a workpiece carrier for receiving the workpiece(s) wherein the workpiece carrier carries one, two or more, if necessary, uniform or different workpieces.

25. Machine tools according to claim 1, characterised in that the machine tools have two machining spindles (3) which are arranged with reference to a center plane symmetrically in the machine tools.

26. Machine tools according to claim 1, characterised in that the machining spindles (3) each have their own drives (32) independent from each other by means of which the distance between the machining spindles can be altered.

27. Machine tools according to claim 1, characterised in that the tool magazine (4) has a disc (47) which carries on its outside tool tongs (46) for picking up the tools (31) and the distance of the tongs (46) can be varied.

28. Machine tools according to claim 1, characterised in that the tool magazine (4) has a disc (47) which carries on its outside tool tongs (46) for picking up the tools (31) and the tongs (46) are supported movably in a linear guide (402) and a tongs adjustment drive (401) changes the distances of the tongs (46) to each other.

29. Machine tools according to claim 1, characterized in that the tool magazine (4) has a disc (47) which carries on its outside tool tongs (46) for picking up the tools (31) and the tongs (46) are supported movably in a linear guide (402) and a tongs adjustment drive (401) changes the distance of the tongs (46) to each other and the tongs adjustment drive (401) is formed by a threaded drive which acts on all tongs (46).

30. Machine tools according to claim 1, characterized in that the tool magazine (4) has a disc (47) which carries on its outside tool tongs (46) for picking up the tools (31) and the tongs (46) are supported movably in a linear guide (402) and a tongs adjustment drive (401) changes the distance of the tongs (46) to each other and the tongs adjustment drive (401) is formed by a threaded drive acting on all tongs (46) and the thread pitch on the threaded drive (401) for the tongs (46) each is different.

31. Machine tools according to claim 1, characterised in that the tool magazine (4) has a disc (47) which carries on its outside tool tongs (46) for picking up the tools (31) and the tongs (46) are supported movably in a linear guide (402) and a tongs adjustment drive (401) changes the distance of the tongs (46) to each other and the tongs adjustment drive (401) is formed by a treaded drive which acts on all tongs (46) and the direction of the thread on the threaded drive (401) for the tongs (46) each is different.

32. Machine tools according to claim 1, characterised in that the tool magazine (4) has a disc (47) which carries on its outside tool tongs (46) for picking up the tools (31) and on the circumference of the disc (47) alternately each with at least to sets of tongs with k tongs each are provided and the tongs of a tongs set (6, 60) each are located on a tongs line (61, 62).

33. Machine tools according to claim 1, characterised in that the tool magazine (4) has a disc (47) which carries on its outside tool tongs (46) for picking up the tools (31) and on the circumference of the disc (47) alternately each with at least two tongs sets with k tongs each are provided and the tongs of a tongs set (6, 60) are located on a tongs line (61, 62) and the tongs lines (61, 62) of different tongs sets (6, 60) cross each other with the adjustment angle alpha.

34. Machine tools according to claim 1, characterised in that the tool magazine (4) has a disc (47) which carries on its outside tool tongs (46) for picking up the tools (31) and on the circumference of the disc (47) alternately each with two tongs sets with k tongs each are provided and the tongs of a tongs set (6, 60) are located on a tongs line (61, 62) each and the tool magazine (4) can offer by means of rotating the disc (47) around the adjustment angle alpha of the machining unit (3) a new set of tongs for changing or exchanging of tools.

35. Machine tools according to claim 1, characterised in that the tool magazine (4) has a disc (47) which carries on its outside tool tongs (46) for picking up the tools (31) and the tongs (46) are guided and held in elongated holes (403) and therefore an adjustment is possible.

36. Machine tools according to claim 1 characterised in that the tool magazine (4) has a disc (47) which carries on its outside tool tongs (46) for picking up the tools (31) and tongs slabs (404) are provided which carry one or more tongs (46), respectively sets of tongs, the tongs slab (404) being able to be connected as a whole with the disc (47).

37. Machine tools according to claim 1, characterised in that the tool magazine (4) has a magazine door (44) which is open in the case of the tool change.

38. Machine tools according to claim 1, characterised in that the tool magazine (4) has a magazine door (44) which is open in the case of the tool change and the movement of opening the magazine door (44) is deviated from the movement of the tool magazine (4) on the supporting beam (10).

39. Machine tools for the in particular cutting machining of workpieces by means of a machining unit having at least one machining spindle, a tool magazine being provided which serves for supplying and changing the tools on the machining spindle, characterised in that the tool magazine (4) is held by a supporting beam (10) which penetrates the tool magazine (4).

40. Machine tools according to claim 1, characterised in that the tool magazine (4) is designed movably towards the machining spindles (3).

41. Machine tools according to claim 1, characterised in that the tool magazine of the machine tools is held by a supporting beam (10) which extends essentially rectangular to the machining spindle.

42. Machine tools according to claim 1, characterized in that the tool magazine of the machine tools is held by a supporting beam (10) which extends essentially parallel to the machining spindle.

43. Machine tools according to claim 1, characterised in that the tool magazine of the machine tools is held by a supporting beam (10), and the supporting beam (10) forms a crosshead between the columns, and the columns, on the other hand, have means for receiving the workpiece.

44. Machine tools according to claim 1, characterised in that the tool magazine of the machine tools is held by a supporting beam (10), and the tool magazine (4) has a supporting beam part (40) which can be put into the supporting beam (10).

45. Machine tools according to claim 1, characterised in that the tool magazine of the machine tools is held by a supporting beam (10) and the tool magazine (4) has a recess (41) in the region of the penetration of the supporting beam (10).

46. Machine tools according to claim 1, characterized in that the tool magazine of the machine tools is held by a supporting beam (10), and the tool magazine (4) has a motion drive (42), for example a working cylinder, which allows a movement of the tool magazine (4) essentially rectangular to the extension of the supporting beam using the recess (41).

47. Machine tools according to claim 1, characterized in that the tool magazine is held by a supporting beam (10), and the tool magazine (4) has a recess (41) in the region of the penetration of the supporting beam (10), and the tool magazine (4) has a guide (43) in the region of the recess (41) and the part (40) of the supporting beam can be moved sledge-like on the guide (43).

48. Machine tools according to claim 1, characterised in that the tool magazine of the machine tools is held by a supporting beam (10) and the supporting beam (10) serves for strutting the tool magazine (4).

49. Machine tools according to claim 1, characterized in that the tool magazine of the machine tools is held by a supporting beam (10) and the supporting beam (10) extends above the machining unit (2).

50. Machine tools according to claim 1, characterised in that the tool magazine of the machine tools is held by a supporting beam (10) and the supporting beam (10) is essentially parallel to the spindle axis (30) of the machining spindle.

51. Machine tools according to claim 1, characterized in that the tool magazine of the machine tools is held by a supporting beam (10) and the supporting beam (10) traverses the working room (13).

52. Machine tools according to claim 1, characterized in that the tool magazine of the machine tools is held by a supporting beam (10) and columns (11) connected with the machine tools bed (12) are provided which hold the supporting beam (10).

53. Machine tools according to claim 1, characterized in that the tool magazine (4) can be lowered vertically.

54. Machine tools according to claim 1, characterised in that the machine tools have at least two machining units with at least one machining spindle each.

55. Machine tools according to claim 1, characterized in that the different machining spindles work the workpiece from different sides.

56. Machine tools according to claim 1, characterized in that the tool magazine of the machine tools is held by a supporting beam (10) and the tool magazine (4) can traverse on the supporting beam (10).

57. Machine tools according to claim 1, characterised in that the tool magazine (4) serves for changing the tools (31) of the machining spindle of several machining units (2).

58. Machine tools according to claim 1, characterized in that the tools (31) in the tool magazine (4) are arranged in multiple rows.
